(19) United States
(12) Patent Application Publication
(10) Pub. No.: US 2003/0188540 A1
(43) Pub. Date: Oct. 9, 2003

(54) COOLING SYSTEM FOR A BEVERAGE DISPENSER

(76) Inventor: John Van Winkle, Walton, KY (US)

Correspondence Address: TAFT, STETTINIUS & HOLLISTER LLP, SUITE 1800, 425 WALNUT STREET, CINCINNATI, OH, 45202-3957, US

(21) Appl. No.: 10/123,429

(22) Filed: Apr. 16, 2002

Related U.S. Application Data
(60) Provisional application No. 60/369,697, filed on Apr. 3, 2002.

(51) Int. Cl. F25B 21/02; B67D 5/62

(52) U.S. Cl. 62/3.64; 62/389; 62/390

(57) ABSTRACT

A fluid cooling device for a beverage dispenser that includes: (a) a fluid accumulation vessel; and (b) a bank of thermoelectric devices provided on at least one external surface of the accumulation vessel and having cooling and heating surfaces, where the cooling surfaces are in thermal communication with the fluid accumulation vessel such that when power is supplied to the devices, the cooling surfaces decrease the thermal energy of the fluid within the accumulation vessel. Additionally, a method of cooling a fluid within a beverage dispenser that includes the steps of: (a) providing a fluid to be cooled within a vessel; (b) positioning a plurality of thermoelectric devices having cooling and heating surfaces to cover a substantial portion of an exterior surface(s) of the vessel, where the cooling surface(s) are in conductive thermal communication with the vessel; and (c) transferring thermal energy from the fluid, through the vessel and into the cooling surfaces, thereafter to be transferred to the heating surfaces.

### CROSS-REFERENCE TO RELATED APPLICATION

This application claims the benefit of U.S. Provisional Application No. 60/369,697, entitled “COOLING SYSTEM FOR A BEVERAGE DISPENSER”, filed Apr. 3, 2002.

### BACKGROUND

1. Field of the Invention

The present invention relates to a fluid thermal energy exchanger system for a beverage dispenser and associated methods of use and manufacture. More particularly, the invention is related to such liquid thermal energy exchanger systems, utilizing commercially available thermoelectric heat transfer devices that have the capability to concurrently provide heating and cooling on opposing sides of the device.

2. Description of the Related Art

The heating and/or cooling of liquid in transit or at a point of accumulation has been effectuated in a multitude of fashions dating back as far as the origin of the very reasons for such heat transfer. Older pieces of art typically center around heat transfer from or to a fluid by the circulation of currents from one region to another, or by the emission and propagation of energy in the form of rays or waves.

More specifically, in the area of cooling liquids which are ingested by human beings, it is well known in the art that mechanical cooling systems may be utilized. These mechanical systems general include a compressor, an evaporator and a condenser connected in a closed refrigeration loop. While not being limited to the aforementioned mechanical cooling systems, the prior art also teaches the use of commercially available thermoelectric devices to bring about cooling and/or heating.

These thermoelectric devices are generally manufactured from two ceramic wafers and a series of “P & N” doped semiconductor blocks sandwiched therebetween. The ceramic wafered thermoelectric devices provide concurrent thermal energy absorption and dissipation on the opposing wafers. These devices take advantage of the Peltier effect; a phenomenon which occurs whenever electrical current flows through two dissimilar conductors. Depending upon the flow of the current, the junction of the two conductors will either absorb or dissipate thermal energy.

### SUMMARY OF THE INVENTION

The present invention relates to a fluid thermal energy exchanger system for a beverage dispenser and associated methods of use and manufacture. The invention may utilize a plurality of thermoelectric devices manufactured from two ceramic wafers and a series of “P & N” doped semiconductor blocks sandwiched therebetween to form a bank of thermoelectric devices capable of concurrent thermal energy absorption and dissipation on the opposing surfaces.

The invention utilizes this concurrent thermal energy absorption and dissipation on opposing surfaces to create thermal gradients between the fluid. If the target is a fluid, such as water to be cooled, the temperature of the water and the temperature of the cooler surface of the wafer are the points of reference for determining the thermal energy gradient. So long as the mean temperature of the cooler surface is less than that of the target, thermal energy will be drawn from the target and absorbed by the cooler surface, thereby cooling the target. In some applications in which the target is a fluid, it may not be desired to have the thermoelectric device come into direct contact with the target; only thermal communication is necessary for thermal energy transfer. As such, the fluid targets may be contained in a reservoir or a conduit. In these examples, the thermoelectric device will not necessarily be in direct contact with the fluid, but may be positioned such that thermal energy may be exchanged between the target and at least one surface of the thermoelectric device.

In particular, the thermoelectric devices may be positioned in such a manner so as to cool or heat beverages or beverage ingredients. In an illustrative example, water from a water source may be cooled by the present invention before being mixed with other ingredients (if desired) and dispensed to the drinking vessel. Alternatively, the water may pass within thermal communication of the warmer surface and thereby be heated before being mixed and dispensed. In these examples, thermal communication allows for the exchange of thermal energy between the water and at least one surface of the thermoelectric device. In an exemplary embodiment, the cooler surface is in thermal communication with an external surface of a vessel or conduit, which is in thermal communication with the target fluid. The process of thermal energy transfer from a contained target to the warmer surface in a cooling operation includes: thermal energy leaving the target fluid and being absorbed by the material of the vessel or conduit; thermal energy leaving the vessel or conduit material and being absorbed by the cooler surface of the thermoelectric device; and, thermal energy being moved or pumped, from the cooler surface along with thermal energy produced from the resistance to current flow, to the warmer surface of the thermoelectric device.

Advantageously, the ceramic wafered thermoelectric devices operate on relatively low power and voltages and are relatively durable. Because the ceramic wafered thermoelectric devices dissipate heat on the side (warming side) of the device opposite that of the cooling side (absorbing heat), the above described exemplary embodiments of the invention may utilize a heat sink to improve dissipation of such excess thermal energy from the warming side.

It is a first aspect of the present invention to provide a fluid cooling device for a beverage dispenser that includes: (a) a fluid accumulation vessel having a fluid outlet and a fluid inlet; and (b) a bank of thermoelectric devices, where the thermoelectric devices have cooling surfaces and heating surfaces, where the cooling surfaces are in conductive thermal communication with the fluid accumulation vessel such that when power is supplied to the thermoelectric devices the cooling surfaces become cool thereby decreasing in thermal energy a fluid within the fluid accumulation vessel, and where the bank of thermoelectric devices are provided on a substantial portion of at least one external surface of the fluid accumulation vessel.

It is a second aspect of the present invention to provide a fluid cooling device for a beverage dispenser that includes: (a) a fluid accumulation vessel having a fluid outlet and a fluid inlet; (b) a bank of thermoelectric devices, where the thermoelectric devices have cooling surfaces and heating surfaces, where the cooling surfaces are in conductive thermal communication with the fluid accumulation vessel such that when power is supplied to the thermoelectric devices the cooling surfaces become cool thereby decreasing in thermal energy a fluid within the fluid accumulation vessel, and where the plurality of thermoelectric devices are provided on a substantial portion of at least one external surface of the fluid accumulation vessel; (c) a heat sink being in conductive thermal communication with the heating surfaces of the bank of the thermoelectric devices; and (d) at least one fan producing convective currents relative to the heat sink.

It is a third aspect of the present invention to provide an apparatus adapted for use in a beverage dispenser that includes: (a) a water accumulation vessel having a water outlet and a water inlet, where the water inlet provides water to the water accumulation vessel from a water source, and where the water source is either a public water source, a bottled or purified water source or a private or well water source; (b) a first bank of thermoelectric devices, where the thermoelectric devices have cooling surfaces and heating surfaces, where the cooling surfaces are in conductive thermal communication with the water conduit such that when power is supplied to the thermoelectric devices the cooling surfaces become cool thereby decreasing in thermal energy water within the water accumulation vessel, and where the first bank of thermoelectric devices are provided on a substantial portion of at least a first external surface of the water accumulation vessel; (c) a heat sink in conductive thermal communication with the heating surfaces of the first bank of thermoelectric devices; (d) a fan providing forced convection in relation to the heat sink; and (e) a carbonator having a cool water inlet and a carbon dioxide inlet, where the cool water inlet is in fluid communication with the water outlet of the water accumulation vessel.

It is a fourth aspect of the present invention to provide a cooling unit for a beverage dispenser that includes: (a) a fluid conduit having a fluid inlet and a fluid outlet; and (b) a first bank of thermoelectric devices, where the first bank of thermoelectric devices have cooling surfaces and heating surfaces, where the cooling surfaces are in conductive thermal communication with the fluid conduit such that when power is supplied to the first bank of thermoelectric devices the cooling surfaces become cool thereby decreasing in thermal energy a fluid within the fluid conduit, and where the first bank of thermoelectric devices are provided on a substantial portion of at least a first external surface of the fluid conduit.

It is a fifth aspect of the present invention to provide a cooling unit for a beverage dispenser that includes: (a) a fluid conduit having a fluid inlet and a fluid outlet; (b) a first bank of thermoelectric devices, where the first bank of thermoelectric devices have cooling surfaces and heating surfaces, where the cooling surfaces are in conductive thermal communication with the fluid conduit such that when power is supplied to the first bank of thermoelectric devices the cooling surfaces become cool thereby decreasing in thermal energy a fluid within the fluid conduit, and where the first bank of thermoelectric devices are provided on a substantial portion of at least a first external surface of the fluid conduit; (c) a heat sink in conductive thermal communication with the heating surfaces of the first bank of thermoelectric devices; and (d) at least one fan producing convective currents relative to the heat sink.

It is a sixth aspect of the present invention to provide a method of cooling a fluid within a beverage dispenser that includes the steps of: (a) providing a fluid to be cooled within a vessel; (b) positioning a plurality of thermoelectric devices to cover a substantial portion of at least a first exterior surface of the vessel, where the plurality of thermoelectric devices have cooling surfaces and heating surfaces upon application of power, and where the cooling surfaces are in conductive thermal communication with the vessel; and (c) transferring thermal energy from the fluid, through the vessel and into the cooling surfaces, thereafter to be transferred to the heating surfaces.

It is a seventh aspect of the present invention to provide a method of providing a chilled beverage from a beverage dispenser that includes the steps of: (a) providing a fluid to be cooled within a conduit; (b) positioning a plurality of thermoelectric devices which have cooling surfaces and heating surfaces upon application of power, such that their cooling surfaces are in conductive thermal communication with the conduit; (c) applying power concurrently to the plurality of the thermoelectric devices and a fan, where the fan provides convective currents in relation to a heat sink, which is, in turn, in thermal communication with the cooling surfaces of the thermoelectric devices; (d) transferring thermal energy from the fluid, through the conduit and into the cooling surfaces, thereafter to be transferred to the heating surfaces and heat sink; and (e) supplying the cooled fluid from the conduit to a beverage dispenser unit at a comparably lower temperature as compared to the ambient temperature of the fluid when first entering the conduit.

### BRIEF DESCRIPTION OF THE DRAWINGS

FIG. 1 is a partial schematic of prior art beverage dispenser operations and units;

FIG. 2 is an overhead, partial cross-sectional view of a thermal energy exchanger for a beverage dispenser in accordance with a first exemplary embodiment of the present invention;

FIG. 3 is an overhead, partial cross-sectional view of the thermal energy exchanger for a beverage dispenser in accordance with the first exemplary embodiment of the present invention;

FIG. 4 is a partial schematic of a control system which may be used with the exemplary embodiments of the present invention;

FIG. 5 is a cross-sectional, front or rear elevational view of a thermal energy exchanger for a beverage dispenser in accordance with a second exemplary embodiment of the present invention;

FIG. 6 is an overhead cut-away view showing features of the thermal energy exchanger in accordance with the second exemplary embodiment of the present invention;

### DETAILED DESCRIPTION OF THE PREFERRED EMBODIMENTS

The present invention provides a fluid cooling system and method for exchanging thermal energy between an ingestible fluid (such as a fluid beverage of fluid beverage ingredient) and a thermal energy exchanger for a beverage dispenser. The methods and systems described below are exemplary in nature and are not intended to constitute limits upon the present invention.

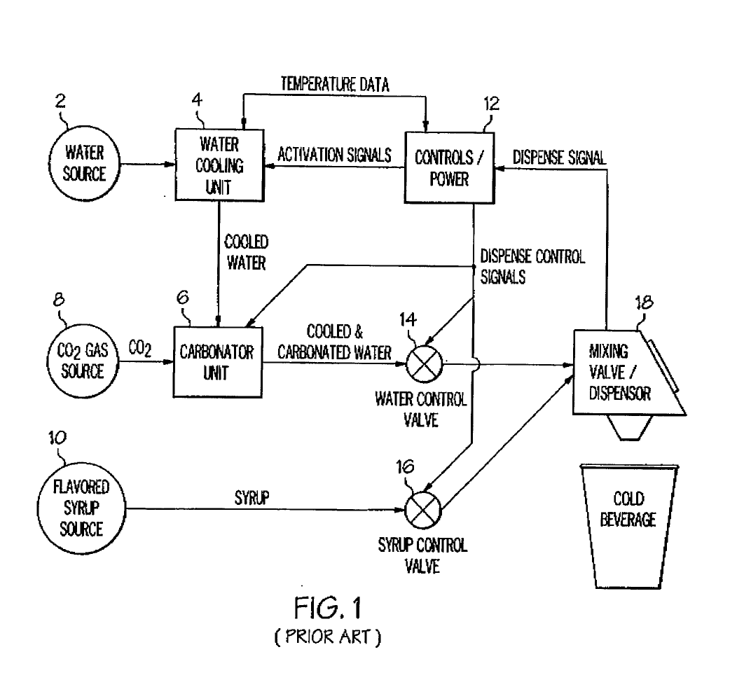

FIG. 1 shows an example beverage dispensing system. The system includes a water source 2, a water cooling unit 4, a carbonator unit 6, carbon dioxide source 8, a flavored syrup source 10, a controller 12, to water control valve 14, a syrup control valve 16 and a mixing valve/dispenser 18. The controller 12 receives temperature data from the water cooling unit 4 relative to the temperature of the water contained within the water cooling unit 4 as well as dispensing signals coming from a mixing valve/dispenser 18 indicating that a user wishes to receive a dispensed beverage. As the controller 12 receives a dispensing signal from mixing valve/dispenser 18, appropriate signals are distributed by the controller 12 to the carbonator unit 6, to water control valve 14 and to the syrup control valve 16 to produce the appropriate beverage. The controller may utilize feedback loops (not shown) connected to the water source 2, the carbon dioxide source 8 and a flavored syrup source 10. These feedback loops monitor the respective source to determine whether any of the water, carbon dioxide or flavored syrup source is empty, thereby requiring replenishment before a user requests a beverage. As an example, a user manipulates the mixing valve/dispenser 18, thereafter sending a signal to the controller which directs a signal to open water control valve 14 and syrup control valves 16 to provide the proper ratio of carbonated water to syrup to produce the beverage requested by the user. All the while, the controller 12 is maintaining the appropriate water level within the water cooling unit 4 and the appropriate amount of carbonated water within the carbonator unit 6. While prior art references have utilized mechanical refrigeration means for the water cooling unit 4, the present invention envisions utilizing a plurality of thermoelectric devices covering a substantial portion of a vessel or conduit through which a fluid is targeted for thermal energy reduction.

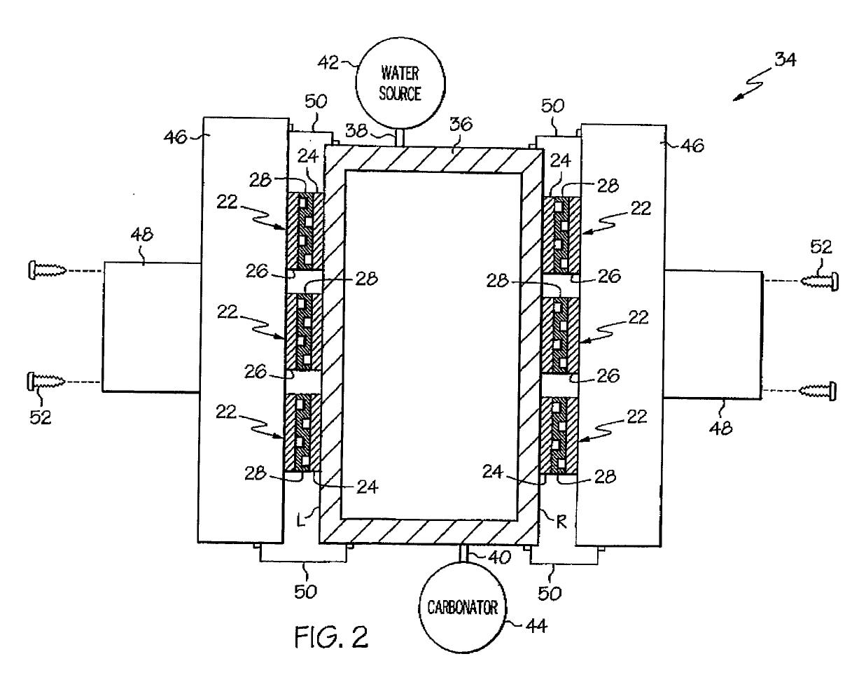

The exemplary embodiments of the present invention utilize commercially-available ceramic wafered thermoelectric devices (CWTDs) that have opposed ceramic surfaces. Upon activation of the CWTDs, one of the ceramic surfaces becomes heated while the opposing one of the ceramic surfaces becomes cooled. For example, as shown in FIG. 2, the CWTDs 22 in the exemplary embodiments, utilize two thin ceramic wafers 24, 26 with a series of bismuth telluride semi-conductor blocks 28 sandwiched therebetween that are sufficiently doped to exhibit an excess of electrons (P) or a deficiency of electrons (N). The wafer material provides an electrically-insulated and mechanically rigid support structure for the thermoelectric device. The “P & N” type semiconductor blocks are electrically interconnected such that, upon electrical activation, and depending upon the polarity, heat is transferred from one ceramic wafer to the opposite wafer causing one ceramic wafer 24 to become cooled while the opposing ceramic wafer 26 becomes hot. The CWTDs 22 are commercially available, for example, as CP2-127-06L from Melcor Corporation, Trenton, N.J. (www.melcor.com).

CWTD 22 has leads (not shown) which provide direct current in the “J” direction to the CWTDs 22, thereby making one wafer 26 warmer in comparison to the other wafer 24 which is cooler. Upon switching of the leads and directing current in the opposite direction, “-J”, the one wafer 26 now becomes the cooler wafer and the other wafer 24 becomes the warmer wafer. This flexibility enables the opposing wafers 24, 26 of the CWTD 22 to change their character (heating to cooling or cooling to heating) simply by changing the direction of direct current flow. The following exemplary embodiments will be explained using the wafer 24 as the cooler wafer, while the wafer 26 will be referred to as the warmer wafer; it will be apparent to those of ordinary skill, however, that, upon switching polarity of the DC power source, the water 24 will be a heating wafer and wafer 26 will be a cooling wafer.

A first exemplary embodiment of a thermal energy exchanger 34 for use as the water cooling unit 4 in a beverage dispenser is shown in FIG. 2. The thermal energy exchanger 34 includes a water accumulation vessel 36, having a water inlet 38 and water outlet 40, that may be connected, for example, to a water source 42 and a carbonator 44. The water accumulation vessel 36 has a rectangular exterior shape thereby exhibiting six exterior surfaces. For explanation purposes only, two surfaces have been chosen which are denoted as surface L and surface R. CWTDs 22 cover a substantial portion of both surface L and surface R. A substantial portion may be 10 to 100 percent of an exterior surface and may be accomplished with a single CWTD or a plurality of CWTDs. In the exemplary embodiment, an array of four CP2-127-06L CWTDs 22 are used on each side, providing approximately 960 BTUs of cooling on each side of the vessel 36. Separate heat sinks 46 are also mounted to CWTDs 22. These heat sinks 46 have a planar surface which may directly abut the CWTDs 22, thereby sandwiching the CWTDs 22 between the respective accumulation vessel surfaces L, R. Electric fans 48 may also be mounted to the heat sinks 46 to assist in the dissipation of thermal energy.

Referencing FIG. 2, assembly of a first exemplary embodiment of a beverage dispenser thermal energy exchanger 34 may begin by positioning the CWTDs 22 so as to be in thermal communication with the water accumulation vessel 36 and the heat sinks 46. The warmer wafers 26 are positioned to be in thermal communication with at least a portion of the heat sinks 46, while the cooler wafers 24 are positioned to be in thermal communication with at least one exterior surface of the water accumulation vessel 36. In the exemplary embodiment, the warmer wafers 26 are adjacent to, and in contact with the heat sinks 46 while the cooler wafers 24 are adjacent to, and in contact with the water accumulation vessel 36. However, it is not necessary that any, or the entire surface of the warmer wafers 26 be in direct contact with a heat sink 24, nor that the cooler wafers 24 be in direct contact with the water accumulation vessel 36, so long as thermal communication is preserved. Each heat sink 24 is thereafter mounted to the water accumulation vessel 24 utilizing brackets 50; however, any chemical or mechanical technique, without limitation, such as employing an epoxy resin, adhesive or compression fitting, is acceptable for mounting each heat sink 24 to the water accumulation vessel 36, so long as the technique allows thermal communication between the warmer wafers 26 and a heat sink 24, as well as thermal communication between the water accumulation vessel 36 and the cooler wafers 24. Additionally, a fan 48 is mounted to the heat sinks 46 to provide induced fluid currents over the heat sinks 46 to thereby assist in dissipation of thermal energy from the heat sinks 46. Each attached fan 48 is mounted to the heat sinks 46 via screws 52; yet, any chemical or mechanical technique, without limitation, such as epoxy resin, adhesive or compression fittings may be appropriate so long as the means used for mounting is maintained.

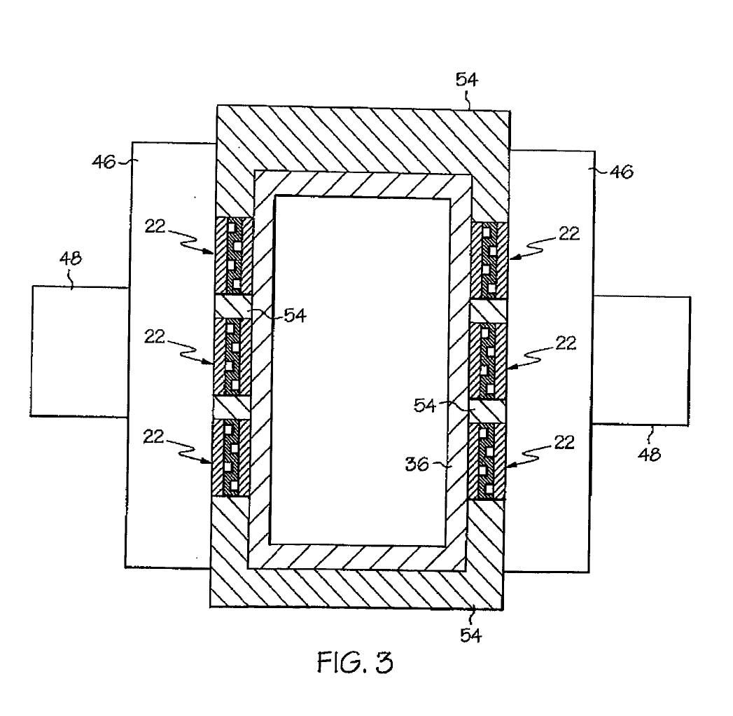

Optionally, as shown in FIG. 3, insulation 54 may be utilized to insulate the exposed portions of the CWTDs 22 as well as exposed portions of the water accumulation vessel 36. The insulation 54 may be any type of insulation which withstands the conditions of intended use and is a poor conductor of thermal energy such as, depending on the circumstances and without limitation, foams (such as latex, stryofoam, polyurethane), glass wools, wood, plastics, rubbers, corks, glass, cotton and aerogels.

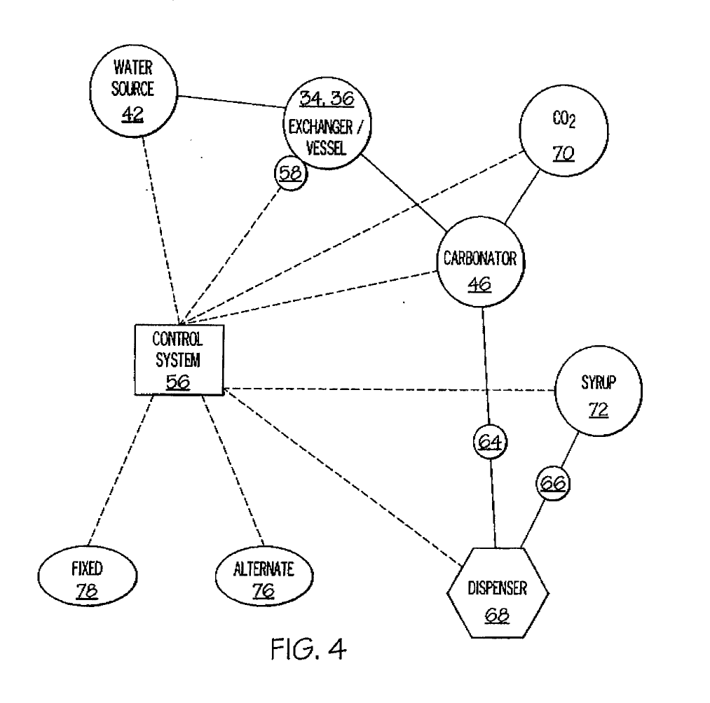

As shown in FIG. 4, a control system 56 may be provided to regulate the temperature of the water within the water accumulation vessel 36 and other units making up the thermal energy exchanger 34. The dashed lines between the units and the controller system 56 represent electrical data connections, while the solid lines represent fluid connections between units. The control system 56, which is readily available to those of ordinary skill in the art, includes a thermal energy detector 58 within the water accumulation vessel and power sources to power the CWTDs 22. Upon an appropriate signal being received from the thermal energy detector 58, indicating that the water within the water accumulation vessel 36 is above a predetermined temperature, the control system 56 will be configured to apply power to the CWTDs 22, thereby cooling the water in the vessel 36 back to a desired temperature. The control system 56 may also manipulate the water control valve 64 and the syrup control valve 66 upon receiving an appropriate signal from the mixing valve/dispenser 68 indicating a user desires a cool beverage to be dispensed. Finally, the control system 56 may also manage the functions of the carbonator unit 46 as well as monitor the water source 42, the carbon dioxide source 70 and the flavored syrup source 72 to determine if replacement/replenishment of an empty or faulty source is necessary.

As will be apparent to those of ordinary skill, the control system 56 discussed above may be used with any of the thermal energy exchangers 34 described or claimed herein. A manual switch (not shown) may also be provided to allow a user to power the exchanger 34 when no control system 56 is present, or to override the control system 56 if necessary. The power sources may also be configured to supply continuous electrical power to the exchanger 34 from a fixed power source 78, or to receive power from an alternate power source 76 should any one or more fixed power sources 78 fail to provide the necessary power for the exchanger 34 to adequately operate. The alternate power source 76 may be, for example, an electrical outlet within a wall, an electrical outlet as provided by a portable generator or other device which supplies an AC source. Fixed power sources 78 include all batteries and other means which provide a DC source. Those of ordinary skill will appreciate that many other types of fixed and alternate power sources are available. It is also within the scope of the present invention that alternate power sources be teamed with converters which transform the alternating current source into a direct current source.

The heat sinks 46 and the water accumulation vessel 36 may be either a homogeneous or heterogeneous material, or combination of materials, having heat transfer properties characterized by being a good conductor of thermal energy. In the exemplary embodiment, the heat sinks 46 are machined aluminum, while the water accumulation vessel 36 is manufactured from aluminum components. The water accumulation vessel 36 may also be constructed mostly from an insulative material(s), where only the sides (L, R) of the vessel 36 in thermal communication with the CWTDs 22 are made of heat transfer material such as aluminum. Additionally, the heat sinks 46 may be finned to allow a greater surface area to volume ratio in an attempt to maximize the potential for thermal energy dissipation as compared to a perfectly round object having no planar surfaces. It will be recognized by those of ordinary skill that other heat conductive materials and other heat sink designs than those shown could be utilized for, or in place of, the heat sinks 46 to provide or improve upon the overall heat transfer without departing from the spirit and scope of the present invention.

It will be appreciated that the thermal energy exchanger 34 of the first exemplary embodiment may be assembled with, or retrofitted to beverage dispensers utilizing water, concentrates, carbonated fluids and other ingestible fluids and beverage ingredients. It will be understood by those of ordinary skill that many of the aforementioned applications of the thermal energy exchanger 34 have been described and are directed to present beverage dispensers being retrofit or retrofitted, however, it is within the scope and spirit of the present invention that the systems and applications described above may be incorporated into the production of new beverage dispensers.

It is within the scope and spirit of the present invention that the thermal energy exchanger 34 of the first exemplary embodiment may for example, have intended uses including, without limitation, the heating of ingestible fluids such as coffee, tea or water, or heating beverage ingredients. As discussed above, this could be accomplished by switching the polarity of the CWTDs' power source, or by flipping the CWTDs over. The thermal energy exchanger may be manufactured with, or retrofitted to a beverage dispenser for the heating or pre-heating of ingestible fluids or beverage ingredients. Additionally, the thermal energy exchanger may be utilized to regulate the temperature of ingestible fluids when the fluids are exposed to environmental conditions tending to decrease the internal and/or thermal energy of the fluid.

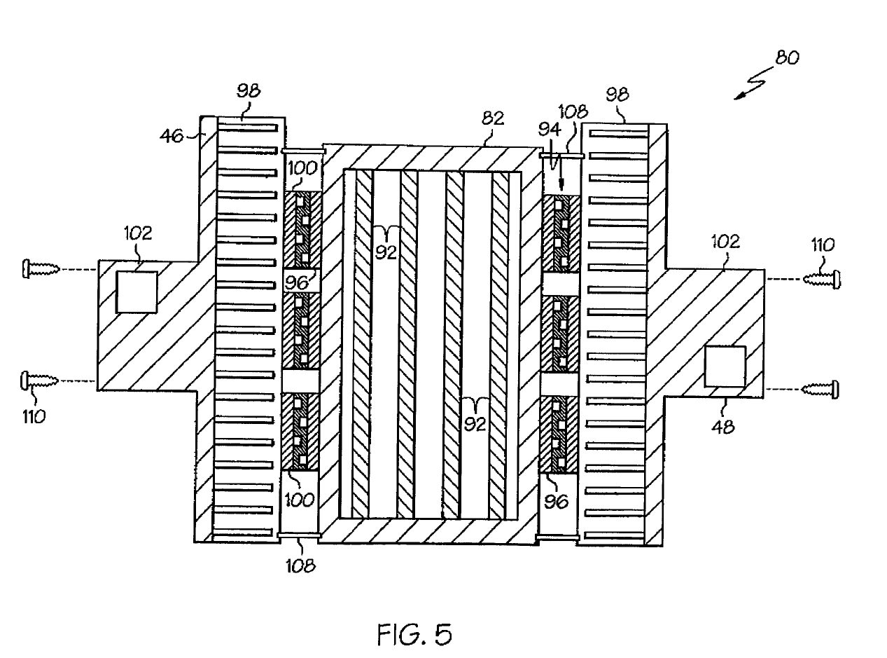

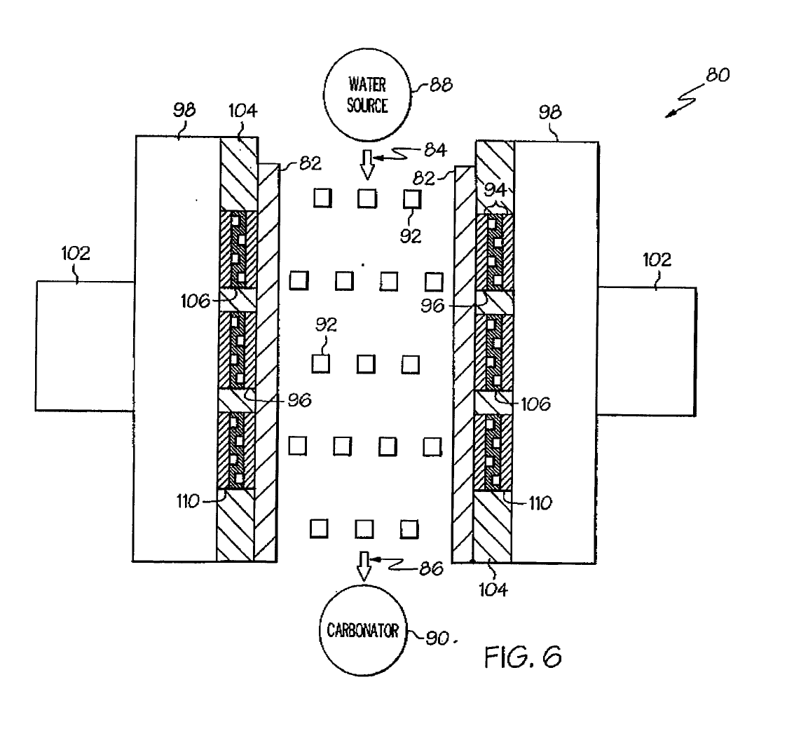

As shown by FIGS. 5 and 6, a second exemplary embodiment of the thermal energy exchanger 80 is used in conjunction with a water conduit 82, for example, such as a beverage dispenser water conduit delivering cooled water to a carbonator. The water conduit 82 includes an inlet 84 for water coming from a water source 88, and an outlet 86 delivering water to a carbonator 90 or other unit of the beverage dispenser where cooled water is desired. The thermal energy exchanger 80 may include heat transfer fixtures 92 that are placed within the water conduit 82 and into contact with the water flowing therein. These fixtures 92 help provide turbulent flow of water within the water conduit 82, thereby maximizing (as opposed to laminar flow) the heat transfer potential between the water and the cooler wafer 96. CWTDs 94 are positioned to allow thermal communication between the cooler wafers 96 and the surface of the water conduit 82. The heat sinks 98, having a plurality of heat dissipating fins, are mounted to the CWTDs 94 so as to provide thermal communication between the warmer wafers 100 and the heat sinks 98. Additionally, a fan 102 is mounted to each of the of heat sinks 98, to provide induced air currents traveling past the heat sinks 98, thereby helping dissipation of heat therefrom.

Referencing FIGS. 5 and 6, assembly of the second exemplary embodiment of the thermal energy exchanger 80 may begin by positioning the CWTDs 94 so as to be in thermal communication with a water conduit 82 and the heat sinks 98. The warmer wafers 100 are positioned to be in thermal communication with at least a portion of the heat sinks 98, while the cooler wafers 96 are positioned to be in thermal communication with at least one exterior surface of the water conduit 82. In the exemplary embodiment, the warmer wafers 100 are adjacent to, and in contact with the heat sinks 98 while the cooler wafers 96 are adjacent to, and in contact with the water conduit 82. However, it is not necessary that any, or the entire surface of the warmer wafers 100 be in direct contact with a heat sink 98, nor that the cooler wafers 96 be in direct contact with the water conduit 82, so long as thermal communication is preserved. Each heat sink 98 is thereafter mounted to the water conduit 82 utilizing brackets 108; however, any chemical or mechanical technique, without limitation, such as employing an epoxy resin, adhesive or compression fitting, is acceptable for mounting each heat sink 98 to the water conduit 82, so long as the technique allows thermal communication between the warmer wafers 100 and a heat sink 98, as well as thermal communication between the water conduit 82 and the cooler wafers 96. Additionally, a fan 102 is mounted to the heat sinks 98 to provide induced fluid currents over the heat sinks 98 to thereby assist in dissipation of thermal energy. Each attached fan 102 is mounted to a heat sink 98 via screws 110; yet, any chemical or mechanical technique, without limitation, such as epoxy resin, adhesive or compression fittings may be appropriate so long as the means used for mounting is maintained.

When activated the CWTDs 94 will cause a induced thermal gradient to be developed between the water within the water conduit 82 and the cooler wafers 96. The induced thermal gradient provides a driving force for heat transfer from the water to the cooler wafers 96 so long as the temperature of the water within the water conduit 82 is greater than the temperature of the cooler wafers 96. As a result of this induced thermal gradient, heat will be transferred from the water, through the heat transfer fixtures 92 and water conduit 82, through the cooler wafers 96 to the warmer wafers 100, and finally transferred from the warmer wafers 100 to the heat sinks 98. Additionally, a control system such as described with respect to FIG. 4 may be provided to regulate the temperature of the water within the water conduit 82 in the same manner as the control system regulated the water temperature within the water accumulation vessel, along with the other features of the control system described above.

The CWTDs 94 are positioned in proximity to the surface of the water conduit 82 such that a substantial portion of an exterior surface of the water conduit 82 is covered. In the second exemplary embodiment, the water conduit 82 has a rectangular cross-section, thereby providing at least four planar surfaces for placement of CWTDs 94. A substantial portion may be 10 to 100 percent of an exterior surface. It will be appreciated by one of ordinary skill that the covering may be accomplished with a single CWTD or a plurality of CWTDs. It will also be appreciated by one of ordinary skill that circular cross-sections may be cooled utilizing the second exemplary embodiment. In these cases, it is within the scope of the present invention to utilize a heat transfer material having a planar surface that is in thermal communication with CWTDs 94, and thermal communication between a surface configured to mate with a curved or non-planar exterior surface of a conduit and the conduit itself.

Optionally, insulation 104 may be utilized to insulate the exposed portions of the semiconductor blocks 106 and the water conduit 82. The insulation 104 may be any type of insulation which withstands the conditions of intended use and is a poor conductor of thermal energy such as, depending on the circumstances, foams (such as latex, stryofoam, polyurethane), glass wools, wood, plastics, rubbers, corks, glass, cotton and aerogels.

It will be understood by those of ordinary skill in the art that the heat transfer fixtures of FIGS. 5 and 6 illustrate exemplary projections of heat transfer fixtures 92 extending into the water flow to assist in the heat transfer between the water within the water conduit 82 and the CWTDs 94, and that many alternate designs, sizes and arrangements of projections will fall within certain aspects of the present invention. It will also be understood by those of ordinary skill that it is not necessary to utilize heat transfer fixtures 92 or any alternate projection extending within the water flow in order to fall within the scope of the invention, since it is possible for sufficient heat transfer to occur through the wall of the water conduit 82 to the CWTDs 94.

It is to be understood that with the embodiments shown in FIGS. 5 and 6, it is not necessary that any, or the entire surface of the cooler wafers 96 be in direct contact with the water conduit 82, nor that the warmer wafers 100 be in direct contact with the heat sinks 98, so long as thermal communication is preserved. The CWTDs 94 may be secured to the water conduit 82 and the heat sinks 98 by any chemical or mechanical technique, without limitation, such as epoxy resin or compression fittings which allows for thermal communication between the water conduit 82 and the heat sinks 98 and their respective cooler 96 and warmer wafers 100 of the CWTDs 94.

The heat sinks 98 and the water conduit 82 may be either a homogeneous or heterogeneous material, or combination of materials, having heat transfer properties characterized by being a good conductor of thermal energy. In the exemplary embodiment, the heat sinks 98 are machined aluminum, while the water conduit 82 is extruded aluminum. As shown in FIG. 5, the heat sinks 98 may be finned to allow a greater surface area to volume ratio in an attempt to maximize the potential for thermal energy dissipation as compared to a perfectly round object having no planar surfaces. It will be recognized by those of ordinary skill that other heat conductive materials and other heat sink designs than those shown could be utilized for, or in place of, the heat sinks to provide or improve upon the overall heat transfer without departing from the spirit and scope of the present invention.

It is within the scope and spirit of the present invention that the thermal energy exchanger of the second exemplary embodiment may for example, have intended uses including, without limitation, the heating of ingestible fluids. As discussed above, to bring about the heating of ingestible fluids, the direction of the current to the existing thermoelectric devices could be inverted or the wafers being flipped over. When utilized in applications advantageous for the heating of ingestible fluids such as water, hot chocolate, coffee, tea, etc., the thermal energy exchanger 80 may be assembled with, or retrofitted to a beverage dispenser for providing ingestible fluids at a dispensing point having increased internal and/or thermal energy. Additionally, the thermal energy exchanger 80 may simply be utilized to regulate the temperature of ingestible fluids when the beverage dispenser is exposed to environmental conditions tending to decrease the internal and/or thermal energy of the contained ingestible fluids.

The thermal energy exchanger systems described herein may be assembled with, or retrofitted to current beverage dispensers utilizing fluid ingredients such as water, juices, coffees, teas, milks and carbonated fluids.

As will be apparent to those of ordinary skill, other materials having good heat transfer properties may be positioned in any manner between the surface of a vessel or conduit such that thermal communication can occur between the vessel/conduit and the surface of the CWTD. These so-called heat transfer materials may be machined or molded to better mate with the exterior geometries of the vessel or conduit. It is not mandatory that the heat transfer material be in physical contact with the vessel or conduit, only that thermal communication between the two is provided.

For simplification purposes, a majority of the exemplary embodiments have been explained in terms of cooling a beverage or a beverage fluid ingredient. However, one of ordinary skill in the art will readily appreciate that all of the exemplary embodiments could function in a heating capacity for increasing the internal energy of beverage fluid components by either flipping the orientation of the wafer surfaces and maintaining the direction of current flow, by switching the direction of current flow and maintaining the orientation of the wafer surfaces, or by having an alternating bank of hot/cold wafers such that the hot wafers are powered to the exclusion of the cold wafers and vice versa.

As a caveat to the heat transfer materials discussed above, it will be well understood by those skilled in the art that aluminum has a relatively high thermal conductivity (117 Btu/h·ft·° F. at 24° F.)) as compared to other metals such as mild steel (26 Btu/h·ft·° F. at 24° F.) and cast iron (22 Btu/h·ft·° F. at 68° F.). While aluminum's higher thermal conductivity makes it more advantageous to use as a material through which heat or thermal energy will travel, other materials could certainly be used such as cast iron, copper (224 Btu/h·ft·° F. at 24° F.), or more expensive materials such gold (169 Btu/h·ft·° F. at 68° F.) and silver (242 Btu/h·ft·° F. at 24° F.). For the purposes of this invention, therefore, a heat transfer material includes any material (metallic or non-metallic) having a suitable thermal conductivity for allowing heat transfer between the CWTD(s) and the ingestible fluid as well as between the CWTD(s) and the heat sinks. While aluminum is called for in the exemplary embodiments, it will be appreciated that materials with lower or higher thermal conductivity may be suitable “heat transfer materials” for a given application.

Following from the above description and invention summaries, it should be apparent to those of ordinary skill in the art that, while the methods and apparatuses herein described constitute exemplary embodiments of the present invention, it is to be understood that the inventions contained herein are not limited to these precise embodiments and that changes may be made to them without departing from the scope of the inventions as defined by the claims. Additionally, it is to be understood that the invention is defined by the claims and it not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

1. A fluid cooling device for a beverage dispenser comprising:
a fluid accumulation vessel having a fluid outlet and a fluid inlet; and
a bank of thermoelectric devices electrically connected in series, the thermoelectric devices having cooling surfaces and heating surfaces, the cooling surfaces being in conductive thermal communication with the fluid accumulation vessel, such that when power is supplied to the thermoelectric devices the cooling surfaces become cool thereby decreasing in thermal energy a fluid within the fluid accumulation vessel, the bank of thermoelectric devices being provided on a substantial portion of at least one external surface of the fluid accumulation vessel.

2. A fluid cooling device for a beverage dispenser comprising:
a fluid accumulation vessel having a fluid outlet and a fluid inlet;
a first bank of thermoelectric devices, the first bank of thermoelectric devices having cooling surfaces and heating surfaces, the cooling surfaces being in conductive thermal communication with the fluid accumulation vessel, such that when power is supplied to the first bank of thermoelectric devices the cooling surfaces become cool thereby decreasing in thermal energy a fluid within the fluid accumulation vessel, the first bank of thermoelectric devices being provided on a substantial portion of at least a first external surface of the fluid accumulation vessel;
a heat sink, the heat sink being in conductive thermal communication with the heating surface of at least one of the thermoelectric devices; and
at least one fan producing convective currents relative to the heat sink.

3. The fluid cooling device of claim 2, wherein the fluid accumulation vessel has six external sides and has a rectangular cross section.

4. The fluid cooling device of claim 2, wherein the heat sink has a series of fins having at least one planar surface.

5. The fluid cooling device of claim 2, wherein the fluid accumulation vessel is aluminum.

6. The fluid cooling device of claim 2, wherein the fan is a centrifugal fan.

7. The fluid cooling device of claim 2, wherein the fluid accumulation vessel is an aluminum alloy.

8. The fluid cooling device of claim 2, wherein the substantial portion is greater than ten percent.

9. The fluid cooling device of claim 2, wherein the substantial portion is greater than twenty-five percent.

10. The fluid cooling device of claim 2, wherein the substantial portion is greater than fifty percent.

11. The fluid cooling device of claim 2, further comprising a second bank of thermoelectric devices, the second bank of thermoelectric devices having cooling surfaces and heating surfaces, the cooling surfaces being in conductive thermal communication with the fluid accumulation vessel, such that when power is supplied to the second bank of thermoelectric devices the cooling surfaces become cool and decrease the thermal energy of the fluid within the fluid accumulation vessel, the second bank of thermoelectric devices being provided on a substantial portion of at least a second external surface of the fluid accumulation vessel;

12. The fluid cooling device of claim 11, wherein the first external surface is opposite the second external surface.

13. An apparatus adapted for use in a beverage dispenser comprising:
a water accumulation vessel having a water outlet and a water inlet, the water inlet providing water to the water accumulation vessel from a water source, the water source being at least one of a public water source, a bottled or purified water source and a private or well water source;
a first bank of thermoelectric devices, the first bank of thermoelectric devices having cooling surfaces and heating surfaces, the cooling surfaces being in conductive thermal communication with the water accumulation vessel, such that when power is supplied to the first bank of thermoelectric devices the cooling surfaces become cool thereby decreasing in thermal energy water within the water accumulation vessel, the first bank of thermoelectric devices being provided on a substantial portion of at least a first external surface of the fluid accumulation vessel;
a heat sink, the heat sink being in conductive thermal communication with the heating surfaces of the first bank of thermoelectric devices;
a fan, the fan providing forced convection in relation to the heat sink; and
a carbonator having a cool water inlet and a carbon dioxide inlet, the cool water inlet being in fluid communication with the water outlet of the water accumulation vessel.

14. The apparatus of claim 13, further comprising:
a carbon dioxide source, the carbon dioxide source having a carbon dioxide outlet, the carbon dioxide outlet being in fluid communication with the carbon dioxide inlet of the carbonator;
a controller, the controller monitoring the temperature of the water at a location including at least one of,
before entering the water accumulation vessel,
while in the accumulation vessel,
between the accumulation vessel and the carbonator,
while in the carbonator,
after the carbonator; and
at least one valve being controlled by the controller, the valve providing fluid communication between at least one of,
a flavored syrup source and a dispenser,
a carbonated water outlet and the dispenser, and
the outlet of the water source and the water inlet of the water accumulation vessel.

15. A cooling unit for a beverage dispenser comprising:
a fluid conduit having a fluid inlet and a fluid outlet; and
a first bank of thermoelectric devices, the first bank of thermoelectric devices having cooling surfaces and heating surfaces, the cooling surfaces being in conductive thermal communication with the fluid conduit, such that when power is supplied to the first bank of thermoelectric devices the cooling surfaces become cool thereby decreasing in thermal energy a fluid within the fluid conduit, the first bank of thermoelectric devices being provided on a substantial portion of at least a first external surface of the fluid conduit.

16. A cooling unit for a beverage dispenser comprising:
a fluid conduit having a fluid inlet and a fluid outlet;
a first bank of thermoelectric devices electrically connected in series, the first bank of thermoelectric devices having cooling surfaces and heating surfaces, the cooling surfaces being in conductive thermal communication with the fluid conduit, such that when power is supplied to the first bank of thermoelectric devices the cooling surfaces become cool thereby decreasing in thermal energy a fluid within the fluid conduit, the first bank of thermoelectric devices being provided on a substantial portion of at least a first external surface of the fluid conduit;
a heat sink, the heat sink being in conductive thermal communication with the heating surfaces of the first bank of thermoelectric devices; and
at least one fan producing convective currents relative to the heat sink.

17. The cooling unit of claim 16, wherein the heat sink has a series of fins having at least one planar surface.

18. The cooling unit of claim 16, wherein the fluid conduit is aluminum.

19. The cooling unit of claim 16, wherein the fan is a centrifugal fan.

20. The cooling unit of claim 16, wherein the fluid conduit is an aluminum alloy.

21. The cooling unit of claim 16, wherein the substantial portion is greater than ten percent.

22. The cooling unit of claim 16, wherein the substantial portion is greater than twenty-five percent.

23. The cooling unit of claim 16, wherein the substantial portion is greater than twenty-five percent.

24. The cooling unit of claim 16, further comprising a second bank of thermoelectric devices, the second bank of thermoelectric devices having cooling surfaces and heating surfaces, the cooling surfaces being in conductive thermal communication with the fluid conduit, such that when power is supplied to the second bank of thermoelectric devices the cooling surfaces become cool thereby decreasing in thermal energy the fluid within the fluid conduit, the second bank of thermoelectric devices being provided on a substantial portion of at least a second external surface of the fluid conduit;

25. The cooling unit of claim 24, wherein the first external surface is opposite the second external surface.

26. The cooling unit of claim 16, further comprising:
a carbonator having a fluid inlet in fluid communication with the fluid outlet of the fluid conduit;
a beverage dispenser fluid source, the fluid source having a fluid inlet and a fluid outlet, the fluid outlet being in fluid communication with the fluid inlet of the fluid conduit; and
a control unit, the control unit providing power to the bank of thermoelectric devices and the fan when the fluid within the fluid conduit is above a predetermined temperature; and
a flavored syrup source, the flavored syrup source having a syrup inlet and a syrup outlet, the syrup outlet being in fluid communication with a mixing valve.

27. A method of cooling a fluid within a beverage dispenser comprising the steps of:
providing a fluid to be cooled within a vessel;
positioning a plurality of thermoelectric devices to cover a substantial portion of at least a first exterior surface of the vessel, the thermoelectric devices having cooling surfaces and heating surfaces upon application of power, the cooling surfaces being in conductive thermal communication with the vessel;
transferring thermal energy from the fluid, through the vessel and into the cooling surfaces thereafter to be transferred to the heating surfaces.

28. The method of claim 27, wherein the substantial portion is greater than ten percent.

29. The method of claim 27, wherein the substantial portion is greater than twenty-five percent.

30. The method of claim 27, wherein the substantial portion is greater than fifty percent.

31. The method of claim 27, further comprising the step of positioning a plurality of thermoelectric devices to cover a substantial portion of at least a second exterior surface of the vessel, the cooling surfaces being in conductive thermal communication with the vessel.

32. The method of claim 31, wherein the first exterior surface is opposite the second exterior surface.

33. A method of providing a chilled beverage from a beverage dispenser comprising the steps of:
providing a fluid to be cooled within a conduit;
positioning a plurality of thermoelectric devices covering a substantial portion of at least a first exterior surface, the plurality of thermoelectric devices having cooling surfaces and heating surfaces upon application of power, the cooling surfaces being in conductive thermal communication with the conduit;
applying power concurrently to the plurality of the thermoelectric devices and a fan, the fan providing convective currents in relation to a heat sink;
transferring thermal energy from the fluid, through the conduit and into the cooling surfaces, thereafter to be transferred to the heating surfaces; and
supplying a cooler fluid to a beverage dispenser unit at a comparably lower temperature as compared to an ambient temperature of the fluid when first entering the conduit.
